(19) United States
(12) Patent Application Publication
(10) Pub. No.: US 2019/0325000 A1
(43) Pub. Date: Oct. 24, 2019

(54) METHOD AND DEVICE FOR PROVIDING INFORMATION BASED ON TICKET SEARCH

(71) Applicant: Alibaba Group Holding Limited, Grand Cayman (KY)

(72) Inventors: Yan ZHANG, Zhejiang (CN); Qianying HU, Zhejiang (CN); Junjie Zhang, Zhejiang (CN)

(21) Appl. No.: 16/503,182

(22) Filed: Jul. 3, 2019

Related U.S. Application Data
(63) Continuation of application No. PCT/CN2017/118426, filed on Dec. 26, 2017.

(30) Foreign Application Priority Data
Jan. 4, 2017 (CN) 201710003158.8

(51) Int. Cl. G06F 16/9537; G06F 16/955; G06Q 10/02; G06Q 50/14; G06F 16/9538

(52) U.S. Cl. CPC G06F 16/9537; G06F 16/955; G06F 16/9538; G06Q 50/14; G06Q 10/02

(57) ABSTRACT

First information and ticket information related to a travel destination in a search time period are acquired according to the travel destination, valuable reference information is provided for a user through multi-dimensional data information, and the user may make a basic decision for travel time through the first information and the ticket information provided by the method. Through multi-dimensional compound information including the acquired first information and ticket information and the like, the techniques of the present disclosure may assist the user in deciding travel time from various perspectives, and may improve the user experience in information searching. Interaction frequencies between a server terminal and a client terminal and query frequencies through the server terminal are reduced, thus reducing the pressure of a server. Meanwhile, the user may select time more conveniently, simply and quickly, thus enhancing the foreseeability of the user and improving user experience.

### CROSS REFERENCE TO RELATED PATENT APPLICATIONS

This application claims priority to and is a continuation of PCT Patent Application No. PCT/CN2017/118426, filed on 26 Dec. 2017 and entitled “METHOD AND DEVICE FOR PROVIDING INFORMATION BASED ON TICKET SEARCH,” which claims priority to Chinese Patent Application No. 201710003158.8 filed on 4 Jan. 2017 and entitled “METHOD AND DEVICE FOR PROVIDING INFORMATION BASED ON TICKET SEARCH,” which are incorporated herein by reference in their entirety.

### TECHNICAL FIELD

The present disclosure relates to the field of Internet data processing technologies, and, more particularly, to methods and devices for providing information based on ticket search.

### BACKGROUND

With the development and rise of the tourism industry, travelers are paying increasingly more attention to the quality of travel, including travelling time. At present, more travelers may reserve air tickets on the Internet. For a traveler with a specific destination, for example, if he/she wants to go to Japan, but there is no fixed departure time and he/she may travel at any time, the traveler will refer to a lot of information to decide the final travelling time. With the improvement of people's living standards, the price is not the only factor for users to decide the time for travelling. In addition to the air ticket price, they also hope to have more valuable reference information when making decisions. For example, when the ticket is at the lowest price, it may be the local rainy season which may be unsuitable for playing in the sea, or the local climate and temperature at this time are not suitable for travelling, or the like. Or, the user is informed that it is particularly suitable for travelling locally at a certain time period. For example, the local Songkran Festival will be held after two weeks, and the user may go to experience and participate in it at this time.

However, the above reference information at present needs to be obtained through multiple channels, and the travelling time may be decided after comprehensive consideration. Acquisition of relevant information through multiple channels not only causes the problem that it is very troublesome and complicated to find information, but also requires multiple repeated accesses to a server for querying, increasing the number of interactions between the server and the client terminal, which in turn causes problems such as large server burden. Moreover, the user experience is not taken into consideration.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

A ticket-search based information providing method is provided in the present disclosure to solve the above problems in the conventional techniques.

A ticket-search based information providing device is further provided in the present disclosure.

A ticket-search based information providing method is provided in the present disclosure, including:

receiving a ticket search request of a user, wherein the search request includes a search destination;

determining a travel destination for search and a search time period according to the search destination;

acquiring, according to the travel destination and the search time period, first information and ticket information related to the travel destination in the search time period; and

displaying a first user interface of a search result, wherein the first user interface includes a multi-dimensional data presentation area including a first information display area and a ticket information display area, the first information related to the travel destination in the search time period is displayed in the first information display area, and the ticket information is displayed in the ticket information display area.

For example, the ticket information includes prices of tickets to the travel destination at various search time points in the search time period; and

a variation tendency chart of the prices of tickets is displayed in the ticket information display area.

For example, the variation tendency chart of the prices of tickets is presented in one of the following charts: a bar chart, a column chart, and a line chart; and

a variation tendency of the first information in the search time period is displayed in the first information display area, and a variation tendency chart of the first information uses one or a combination of the following charts: a bar chart, a column chart, a pie chart, and a line chart.

For example, the determining a travel destination for search includes:

determining whether the search destination has ticket-related information;

if not, acquiring a related city of the search destination, wherein the related city includes a combination of one or more of the following cities: a city having a hierarchical relationship with the search destination, a city having a regional association with the search destination, and a city adjacent to the search destination; and

determining the travel destination according to the related city of the search destination.

For example, the first information includes weather information of the travel destination at various search time points in the search time period;

the acquiring first information related to the travel destination in the search time period includes: acquiring the weather information of the travel destination at the various search time points in the search time period, and a variation tendency of the weather information; and

a variation tendency chart of the weather information of the travel destination in the search time period is displayed in the first information display area.

For example, the multi-dimensional data presentation area including the first information display area and the ticket information display area, and the method includes:

presenting, in the multi-dimensional data presentation area, a variation tendency chart of prices of tickets and the variation tendency chart of the weather information in the search time period; and

presenting the variation tendency chart of the prices of tickets and the variation tendency chart of the weather information in the same chart by aggregation and superposition.

For example, the first information includes traveler volume information of the travel destination at various search time points in the search time period;

the acquiring first information related to the travel destination in the search time period includes:

acquiring an actual traveler volume of the travel destination at the various search time points in the search time period;

acquiring a predicted traveler volume of the travel destination at the various search time points in the search time period;

determining, according to the actual traveler volume and the predicted traveler volume, the traveler volume information of the travel destination at the various search time points in the search time period and a variation tendency of the traveler volume information in the search time period; and

displaying, in the first information display area, a variation tendency chart of the traveler volume information of the travel destination at the various search time points in the search time period.

For example, the multi-dimensional data presentation area including the first information display area and the ticket information display area, and the method includes:

presenting, in the multi-dimensional data presentation area, a variation tendency chart of prices of tickets and the variation tendency chart of the traveler volume information in the search time period; and

presenting the variation tendency chart of the prices of tickets and the variation tendency chart of the traveler volume information in the same chart by aggregation and superposition.

For example, the acquiring a predicted traveler volume of the travel destination at the various search time points in the search time period includes: acquiring, based on the travel platform, a volume of independent visitors who search for the travel destination, and using the volume of independent visitors as the predicted traveler volume; and

the determining, according to the actual traveler volume and the predicted traveler volume, the traveler volume information of the travel destination at the various search time points in the search time period and a variation tendency of the traveler volume information in the search time period includes:

adding the actual traveler volume and the volume of independent visitors as the traveler volume information; and

determining, according to the traveler volume information at the various search time points in the search time, a variation tendency of the traveler volume information in the search time period.

For example, the first information includes event information of the travel destination;

the event information includes a combination of one or more of the following information: traditional holiday information of the travel destination, low or peak travel season information of the travel destination, recommended travel attraction information of the travel destination, and flowering season information of the travel destination;

the event information presented by identification information in the search time period is displayed in the first information display area; and

a variation tendency chart of prices of tickets and the identification information of the event information in the search time period are presented in the multi-dimensional data presentation area.

For example, the ticket is an air ticket, and the first information includes a combination of one or more of the following information: weather information, traveler volume information, and hotel information;

a variation tendency chart of prices of tickets and the variation tendency chart of the first information in the search time period are displayed in the multi-dimensional data display area; and

the variation tendency chart of the prices of tickets and the variation tendency chart of the first information are presented in different presentation manners in the same chart by aggregation and superposition, and the presentation manners include: a column chart and a line chart.

For example, the determining a search time period includes:

setting a default time period by the system; or

determining a search start date of the search time period according to a current system time, and determining a search end date of the search time period according to the determined search start data and a search time length set by default; and

calculating the search time length in the calculation unit of days or months.

For example, the current system time is previously acquired; and

the displaying a first user interface of a search result, wherein the first information related to the travel destination in the search time period is displayed in the first information display area, and the ticket information is displayed in the ticket information display area includes:

displaying the first information related to the travel destination in the search time period in the first information display area by highlight, and displaying the ticket information in the ticket information display area by highlight.

For example, after the displaying a first user interface of a search result, the method includes:

receiving a monitoring request of the user, wherein the monitoring request includes a monitoring behavior for a time period in the search time period;

querying, according to the monitoring request, second information and ticket information corresponding to a specific time included in the time period; and

displaying a second user interface of a monitoring result, wherein the second user interface includes a second information display area and a ticket information display area, the second information related to the travel destination corresponding to the specific time is displayed in the second information display area, and the ticket information is displayed in the ticket information display area, wherein:

the second information related to the travel destination corresponding to the specific time includes information related to the first information.

A ticket-search based information providing method is further provided in the present disclosure, wherein a database is provided and the database includes a travel destination and first information related to the travel destination, and the first information includes multi-dimensional information, and

the method includes:

receiving an information collection request including the travel destination and a search time period;

collecting, according to the travel destination and the search time period, first information and ticket information related to the travel destination in the search time period; and

sending an information acquisition response including the first information and the ticket information related to the travel destination in the search time period.

For example, the first information includes weather information of the travel destination, and the weather information is collected by:

collecting the weather information of the travel destination at various search time points in the search time period from the database.

For example, the first information includes traveler volume information of the travel destination, and the traveler volume information is collected by:

collecting an actual traveler volume of the travel destination at various search time points in the search time period from the database;

collecting a predicted traveler volume of the travel destination at the various search time points in the search time period from the database; and

determining, according to the actual traveler volume and the predicted traveler volume, the traveler volume information at the various search time points in the search time period.

For example, the determining, according to the actual traveler volume and the predicted traveler volume, the traveler volume information at the various search time points in the search time period includes:

determining the traveler volume information by adding the actual traveler volume and the predicted traveler volume; or

setting a corresponding weight for the actual traveler volume and the predicted traveler volume respectively, and determining the traveler volume information by adding the weighted actual traveler volume and the weighted predicted traveler volume.

For example, the ticket includes an air ticket; and the ticket information includes prices of air tickets in the search time period; and

the acquiring ticket information related to the travel destination in the search time period includes: acquiring the prices of the air tickets from a travel departure place to the travel destination at various search time points in the search time period.

For example, after the sending an information acquisition response, the following operations are performed:

determining whether a monitoring request for a time object is received, wherein the monitoring request includes an area corresponding to the time object of the monitoring request;

if the monitoring request for a time object is received, querying, according to the time object of the monitoring request, second information and ticket information corresponding to the time object; and

sending a monitoring response including the second information and the ticket information corresponding to the time object, wherein the second information is information related to the first information.

A ticket-search based information providing device is further provided in the present disclosure, including:

a receiving unit configured to receive a ticket search request of a user, wherein the search request includes a search destination;

a determining unit configured to determine a travel destination for search and a search time period according to the search destination;

an acquisition unit configured to acquire, according to the travel destination and the search time period, first information and ticket information related to the travel destination in the search time period; and

a display unit configured to display a first user interface of a search result, wherein the first user interface includes a multi-dimensional data presentation area including a first information display area and a ticket information display area, the first information related to the travel destination in the search time period is displayed in the first information display area, and the ticket information is displayed in the ticket information display area.

For example, the determining unit includes:

a determining sub-unit configured to judge whether the search destination has ticket-related information;

a related city acquisition sub-unit configured to, when a judgment result of the determining sub-unit is negative, acquire a related city of the search destination, wherein the related city includes a combination of one or more of the following cities: a city having a hierarchical relationship with the search destination, a city having a regional association with the search destination, and a city adjacent to the search destination; and

a destination determining sub-unit configured to determine the travel destination according to the related city of the search destination.

For example, the ticket is an air ticket, and the first information includes a combination of one or more of the following information: weather information, traveler volume information, and hotel information;

a variation tendency chart of prices of tickets and the variation tendency chart of the first information in the search time period are displayed in the multi-dimensional data display area; and

the variation tendency chart of the prices of tickets and the variation tendency chart of the first information are presented in different presentation manners in the same chart by aggregation and superposition, and the presentation manners include: a column chart and a line chart.

A ticket-search based information providing device is further provided in the present disclosure, wherein a database is provided and includes a travel destination and first information related to the travel destination, and the first information includes multi-dimensional information; and

the device includes:

a receiving unit configured to receive an information collection request including the travel destination and a search time period;

an acquisition unit configured to collect, according to the travel destination and the search time period, first information and ticket information related to the travel destination in the search time period; and

a sending unit configured to send an information acquisition response including the first information and the ticket information related to the travel destination in the search time period.

For example, the first information includes weather information of the travel destination;

the acquisition unit is configured to collect the weather information of the travel destination at various search time points in the search time period from the database.

For example, the first information includes traveler volume information of the travel destination; and

the acquisition unit includes:

an actual traveler volume sub-unit configured to collect an actual traveler volume of the travel destination at various search time points in the search time period from the database;

a predicted traveler volume sub-unit configured to collect a predicted traveler volume of the travel destination at the various search time points in the search time period from the database; and

a traveler volume information sub-unit configured to determine, according to the actual traveler volume and the predicted traveler volume, the traveler volume information at the various search time points in the search time period.

For example, the device further includes:

a determining unit configured to judge whether a monitoring request for a time object is received after the information acquisition response is sent, wherein the monitoring request includes an area corresponding to the time object of the monitoring request;

a query unit configured to, if a judgment result of the determining unit is positive, query, according to the time object of the monitoring request, second information and ticket information corresponding to the time object; and

a sending unit configured to send a monitoring response including the second information and the ticket information corresponding to the time object, wherein the second information is information related to the first information.

A ticket-search based information providing method is further provided in the present disclosure, including:

receiving, by a client terminal, a ticket search request of a user, wherein the search request includes a search destination;

sending a second search request to a server terminal, wherein the second search request includes a departure place, and a travel destination and a search time period related to the search destination determined according to the search destination;

receiving a search result returned by the server terminal, wherein the search result includes first information and ticket information related to the travel destination in the search time period; and

displaying a first user interface of the search result corresponding to the ticket search request, wherein the first user interface includes a multi-dimensional data presentation area including a first information display area and a ticket information display area, the first information related to the travel destination in the search time period is displayed in the first information display area, and the ticket information is displayed in the ticket information display area.

A ticket-search based information providing method is further provided in the present disclosure, wherein a database is provided and includes a travel destination and first information related to the travel destination; and

the method includes:

receiving a search request sent by a client terminal, wherein the search request includes a departure place, a travel destination, and a search time period;

acquiring first information and ticket information related to the travel destination in the search time period; and

returning a search result to the client terminal, wherein the search result includes the first information and the ticket information related to the travel destination in the search time period.

A ticket-search based information providing method is further provided in the present disclosure, including:

receiving, by a client terminal, a ticket search request of a user, wherein the search request includes a search destination;

sending a second search request to a server terminal, wherein the second search request includes a departure place, a search destination, and a search time period;

receiving a search result returned by the server terminal, wherein the search result includes first information and ticket information related to a travel destination in the search time period; and the travel destination is associated with the search destination; and

displaying a first user interface of the search result corresponding to the ticket search request, wherein the first user interface includes a multi-dimensional data presentation area including a first information display area and a ticket information display area, the first information related to the travel destination in the search time period is displayed in the first information display area, and the ticket information is displayed in the ticket information display area.

A ticket-search based information providing method is further provided in the present disclosure, wherein a database is provided and includes a travel destination, first information related to the travel destination, and an association relationship between destinations; and

the method includes:

receiving a search request sent by a client terminal, wherein the search request includes a departure place, a search destination, and a search time period;

determining, according to the search destination, the travel destination related to the search destination;

acquiring first information and ticket information related to the travel destination in the search time period; and

returning a search result to the client terminal, wherein the search result includes the first information and the ticket information related to the travel destination in the search time period.

Compared with the conventional techniques, the present disclosure has the following advantages.

A ticket-search based information providing method is provided in the present disclosure. With the method, first information and ticket information related to a travel destination in a search time period are acquired according to the travel destination, the first information and the ticket information may provide valuable reference information for a user through multi-dimensional data information, and the multi-dimensional data information is important key information that needs to be considered for the travel to the destination. Therefore, the user may make a basic decision for travel time through the first information and the ticket information provided by the method. In sum, by use of the method provided by the present disclosure, through multi-dimensional compound information including the acquired first information and ticket information and the like, it may assist the user in deciding travel time from various perspectives, and it may improve user experience in information searching. The method reduces interaction frequencies between a server terminal and a client terminal and query frequencies through the server terminal, thus reducing the pressure of a server. Meanwhile, the user may select time more conveniently, simply and quickly, thus enhancing the foresee-ability of the user and improving user experience.

### BRIEF DESCRIPTION OF THE DRAWINGS

In order to illustrate the technical solutions in the example embodiments of the present disclosure more clearly, the following briefly describes the accompanying drawings which aid in describing the example embodiments. Apparently, the accompanying drawings in the following description merely show some of the example embodiments of the present disclosure, and persons of ordinary skill in the art may derive other drawings from these accompanying drawings without creative efforts.

FIG. 1 is a flowchart of a ticket-search based information providing method according to Embodiment 1 of the present disclosure;

FIG. 2 is a schematic diagram of applying the method provided in Embodiment 1 of the present disclosure to an air ticket scenario;

FIG. 3 is a schematic diagram of comprehensive information presentation according to Embodiment 1 of the present disclosure;

FIG. 4 is a schematic diagram of reference information presentation according to Embodiment 1 of the present disclosure;

FIG. 5 is a flowchart of a ticket-search based information providing method according to Embodiment 2 of the present disclosure;

FIG. 6 is a schematic structural diagram of a ticket-search based information providing device according to Embodiment 3 of the present disclosure; and

FIG. 7 is a schematic structural diagram of a ticket-search based information providing device according to Embodiment 4 of the present disclosure.

### DETAILED DESCRIPTION

A ticket-search based information providing method is provided in Embodiment 1 of the present disclosure, and may mainly provide a user with reference information for ticket search, so that the user may quickly and efficiently obtain multi-dimensional data information during the ticket search, and the user may use the multi-dimensional data information as reference information for decision making. Therefore, the method provided in the present disclosure may provide convenience for the user in terms of ticket search, thus improving user experience.

The ticket-search based information providing method according to the present disclosure is introduced and illustrated in detail below through specific embodiments.

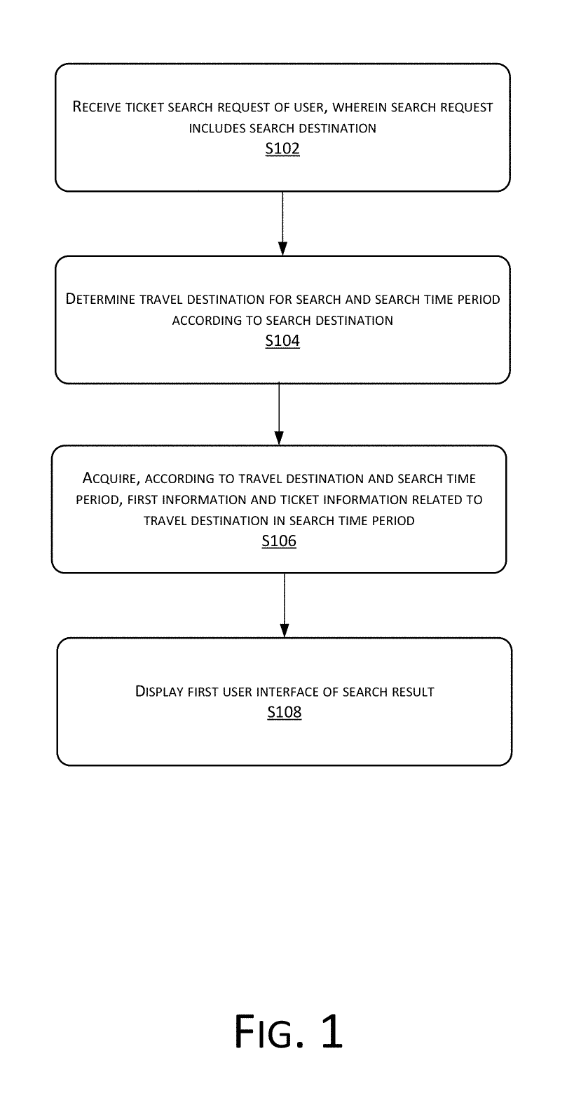

FIG. 1 is a flowchart of a ticket-search based information providing method according to Embodiment 1 of the present disclosure. Referring to FIG. 1, the method includes the following steps.

In step S102, a client terminal receives a ticket search request of a user, wherein the search request includes a search destination.

A scenario to which the method according to the embodiment of the present disclosure is applied may be preset to a travel-related scenario, and more specifically may be a scenario such as ticket query and search involved in the travel behavior. For example, the user may be provided with some reference information about the time of travelling to a certain place, so that the user may quickly and conveniently determine a travelling time and a travelling arrangement according to a platform where the method is implemented. Therefore, the method is mainly introduced and described in detail in the embodiment of the present disclosure by introducing the scenarios and examples involved in user travelling.

In the scenario of travel time and ticket search, the method is applied to designs developed based on a determined travel destination, and therefore, steps of the method should first be determining and acquiring the travel destination selected by the user.

For example, when the ticket is an air ticket, in the scenario of air ticket reservation or air ticket search, a search request of the user is first determined, and the search request needs to include a search destination. Once the search destination is determined, related information for the search destination may be queried and acquired. Once the user selects the travel destination, it indicates that the user has determined a travel destination, and selection of a date of departure is the focus of the embodiment of the present disclosure. Therefore, the next step and acquisition of other information may be determined by the destination input or selected by the user in a destination input box.

It should be noted that the search request is an intentional request of the user, and may be destination information input by the user in a corresponding input box of the search request, or may be selected from common destinations preset by a system, and the client terminal finally receives the user's request for the ticket search regardless of whether it is input or selected.

Still referring to FIG. 1, in step S104, a travel destination for search and a search time period are determined according to the search destination.

This step is a process of determining the travel destination and the search time period according to the search destination. A place database storing association relationships between multiple places may be previously configured to ensure that a search result may be obtained for a place input by the user. After the search destination input by the user is received, the travel destination associated with the search destination may be determined according to the association relationship in the place database. This step may be performed in the client terminal or at the server terminal side. The place database is disposed in the server terminal when this step is performed at the server terminal side. However, in the ticket search scenario, a departure place is further needed in this step. When the user inputs departure place information, the departure place input or selected by the user is used as the departure place of the ticket search. When the user does not select or input a departure place, a current city or place where the user is located is acquired through location information of the terminal as the departure place of the ticket search, or a default place of the system may be used as the departure place.

The travel destination determined in this step and the search destination may be the same place or different places. For example, when the search destination of the user is Paris, it indicates that the travel destination of the user is Paris, and in this case, the search destination is in line with the travel destination.

In addition, it is also possible that there is no related ticket information of the search destination of the user, and in this case, implementation may be made in the following manner: first determining whether the search destination has ticket related information; and if the judgment result is negative, acquiring a related city of the search destination. The related city includes a combination of one or more of the following cities: a city having a hierarchical relationship with the search destination, a city having a regional association with the search destination, and a city adjacent to the search destination; and then the travel destination is determined according to the related city of the search destination.

For example, when the related city is a city having a hierarchical relationship with the search destination, and the search destination is Japan, as Japan is the name of a country, it indicates in this case that the travel destination of the user is one of the cities of Japan. Cities belonging to the country Japan may be searched for, that is, when the search destination is different from the travel destination, the travel destination may be determined according to the search destination in the following manner. First, if the search destination is a country name, specific cities belonging to the country are acquired according to the search destination; and then the travel destination is determined according to the acquired specific cities.

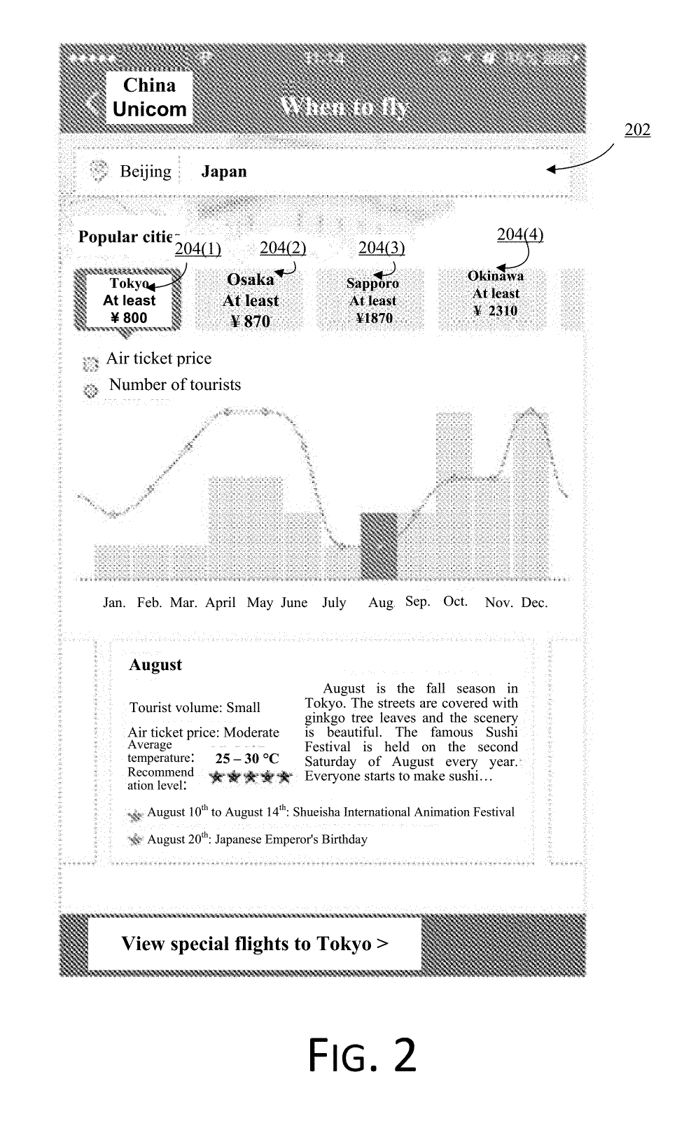

FIG. 2 is a schematic diagram of applying the method provided in Embodiment 1 of the present disclosure to an air ticket scenario. Referring to FIG. 2, after Japan is entered in a search input box, correspondingly, Tokyo, Osaka, and Sapporo in Japan are displayed as search results. In this case, the search destination 202 is Japan, and the travel destination may be one of the four cities Tokyo 204(1), Osaka 204(2), Sapporo 204(3), and Okinawa 204(4). Therefore, when the user searches for a travel to Japan, a corresponding air route date query instruction will be activated, and after the instruction is received, corresponding information will be acquired according to the entered travel destination.

The search time period further needs to be determined in addition to determination of the travel destination.

The search time period is a precondition of acquiring and presenting related information of the travel destination in a certain time period. The process of ticket search is a search for the related information of the travel destination in the certain time period.

The search time period may be determined in a variety of manners, and in the two common determination manners, one is determining the search time period according to a default time period set by a system. The system may preset a certain time period as the search time period. For example, the system may set that the default search time period is one year, calculated in months as units. Determining the search time period in this manner may save the selection operation of the user, thus simplifying the operation to save user time, which may improve user experience.

Another manner of determining the search time period includes: determining a search start date of the search time period according to a current system time, and determining a search end date of the search time period according to the determined search start date and a search time length set by default; and calculating the search time length in days or in months as units.

Determining the search time period in the above manner enables the user to select more freely, and the user may select the search time period according to an actual requirement. The search time period generally starts according to the system time, and a search end date is determined according to a search time length.

For example, when the search time period is calculated in months, if the current system time is December 15, the search start date is set to December, and when the search time length is set to 12 months, it lasts from the current December to November in the next year, so the search end date is November in the next year. Therefore, the search time period is defined as December of this year to November in the next year.

For another example, when the search time period is calculated by days, if the current system time is December 15 and the search time length is set to two months, correspondingly, the search end date is February 15 in the next year. If the search time length is set to 10 days, the search end date is December 25.

It should be noted that it is more flexible when the search time period is determined in the second manner.

Still referring to FIG. 1, in step S106, first information and ticket information related to the travel destination in the search time period are acquired according to the travel destination and the search time period.

This step is a process of acquiring the first information and the ticket information related to the travel destination, and the first information, the ticket information, and the like are acquired according to the determined travel destination. The first information and the ticket information may provide valuable reference information for the user in ticket search. The user may make a travel decision according to the first information and the ticket information without separately acquiring information by searching other platforms. Therefore, the acquisition of the first information and the ticket information may provide convenience for the user to the maximum extent. This step may be performed in the client terminal or at the server terminal side. The database storing the first information is disposed in the server terminal when this step is performed at the server terminal side.

The first information and the ticket information are introduced and illustrated below.

The ticket information includes prices of tickets to the travel destination at various search time points in the search time period. In addition, a variation tendency of ticket prices may be further determined according to the prices of tickets at various search time points in the search time period, and the variation tendency will be presented in the next presentation step.

In addition, the first information is multi-dimensional data, and the multi-dimensional data also varies correspondingly as time changes in the search time period, and the variations are also presented by a variation tendency chart.

The manners of presenting the variation tendency of the first information and the ticket information are introduced and illustrated in detail in the next step.

It should be noted that in the step of acquiring first information and ticket information related to the travel destination in the search time period, the first information and the ticket information are acquired respectively according to the various search time points in the search time period, and the time point is not simply a specific time point, but refers to a preset unit time period. For example, the time point may be a calendar month, and the first information and the ticket information corresponding to each calendar month are acquired by taking the calendar month as a time unit. In addition, the time point may also be one day, and the first information and the ticket information corresponding to each day may be acquired by taking each day as a time unit.

Therefore, the various search time points in the embodiments of the present disclosure should be construed as several time periods resulted by dividing the search time period. The division standard generally refers to the user's common preference, such as taking a month or day as a unit. When the time point is a calendar month, the search time period may be a calendar year including 12 calendar months. Correspondingly, when the time point is day, the search time period may use the number of days included in each month as a calculation unit.

In addition, as introduced above, the first information may include a combination of one or more of the following information: weather information of the travel destination, traveler volume information of the travel destination, and event information of the travel destination, and the like. The listed information may exist separately or in multiple information combinations.

For example, when the first information includes the weather information of the travel destination at the various search time points in the search time period, the acquiring first information related to the travel destination in the search time period includes: acquiring the weather information of the travel destination at the various search time points in the search time period, and a variation tendency of the weather information.

The weather information mainly includes the temperature. As the temperature has a great influence on the travel, it is an important factor to know the temperature of the travel destination in advance especially for a user travelling.

Moreover, the weather information may be acquired from a database or by a meteorological environment system of the server terminal. For example, when a travel destination of a user A is Thailand, the average temperature of each month in one year of Thailand may be obtained by the meteorological environment system. The average temperature is reference information, and the average temperature of each calendar month per year generally does not fluctuate greatly.

The first information being the weather information is introduced above, and in addition, the first information may further include the traveler volume information of the travel destination. The traveler volume information reflects the traveler volume of the travel destination at certain time periods, and may indirectly reflect the low season or peak season of the travel destination. Visitors are more inclined to choose to travel when there are fewer people. Therefore, the traveler volume information is also important reference information.

Correspondingly, the acquiring first information related to the travel destination in the search time period includes: acquiring an actual traveler volume of the travel destination at the various search time points in the search time period; acquiring a predicted traveler volume of the travel destination at the various search time points in the search time period; and determining, according to the actual traveler volume and the predicted traveler volume, the traveler volume information of the travel destination at the various search time points in the search time period and a variation tendency of the traveler volume information in the search time period.

For example, the acquiring a predicted traveler volume of the travel destination at the various search time points in the search time period includes: acquiring, based on a travel platform, a volume of independent visitors who search for the travel destination, and using the volume of independent visitors as the predicted traveler volume; and the determining, according to the actual traveler volume and the predicted traveler volume, the traveler volume information of the travel destination at the various search time points in the search time period and a variation tendency of the traveler volume information in the search time period includes: adding the actual traveler volume and the volume of independent visitors as the traveler volume information; and determining, according to the traveler volume information at the various search time points in the search time, a variation tendency of the traveler volume information in the search time period.

It should be noted that the volume of independent visitors reflects travel plans of the people who want to go to the travel destination, and reflects the predicted traveler volume. Many destination searches aim to travel to the place. Therefore, the volume of independent visitors may reflect the popularity of the travel destination to some extent.

In addition, the corresponding traveler volume at the destination may be queried from many travel platforms. For example, the number of persons who are travelling may be acquired from the platform Mafengwo. Then, the volume of independent visitors and the traveler volume are calculated correspondingly to obtain the traveler volume information in the corresponding unit time period.

In the calculating the traveler volume information of the travel destination according to the volume of independent visitors and the actual traveler volume in a preset calculation manner, the preset calculation manner includes: adding the volume of independent visitors and the actual traveler volume; or setting a corresponding weight for the actual traveler volume and the predicted traveler volume respectively, and obtaining the final traveler volume by adding the weighted volume of independent visitors and the weighted actual traveler volume.

Adding the two directly is easy to understand, and both may reflect the traveler volume corresponding to the travel destination. In addition to adding the two directly, calculation may also be made according to the weights.

For example, users of the volume of independent visitors may only conduct searches but do not actually travel to the place. Therefore, not all the users who conduct searches will actually travel to the place, so a weight may be set. For example, it is set that 70% of the volume of independent visitors becomes real travelers, a corresponding weight may also be assigned to the traveler volume acquired from the platform Mafengwo, and the final adding calculation is performed according to the weight.

The first information and the ticket information may be acquired in a variety of manners, one of which may be storing the collected first information and ticket information locally as local information. In another manner, a corresponding request is sent to the server, the first information and the ticket information are obtained according to the request, and the server sends them to the client terminal, and in this way, the information and the ticket information is obtained.

In addition, the first information may further include event information of the travel destination. The event information includes a combination of one or more of the following information: traditional holiday information of the travel destination, low or peak travel season information of the travel destination, recommended travel attraction information of the travel destination, and flowering season information of the travel destination.

It should be noted that the above event information may be displayed through identification information, and a specific form of displaying may be illustrated in the next step. The identification information may embody the event information, and facilitate the user to identify the corresponding event information.

In addition, level information obtained may be further processed according to the ticket information. For example, when the air ticket price of a calendar month is 1,500 Yuan, the air ticket price of the month is lower in the calendar year, and then the level of the air ticket price of the calendar month may be set to “lower”. In contrast, if the air ticket price for a calendar month is 5,000 Yuan, it indicates that the level of the air ticket price for the calendar month is “higher”. By analogy, the information included in the first information may also be represented by level information. For example, the temperature, the hotel price, etc. may be respectively set to corresponding levels to provide reference for the user.

Still referring to FIG. 1, in step S108, a first user interface of a search result is displayed, wherein the first user interface includes a multi-dimensional data presentation area including a first information display area and a ticket information display area, the first information related to the travel destination in the search time period is displayed in the first information display area, and the ticket information is displayed in the ticket information display area.

The step is a process of displaying the first user interface, and a search result of the above steps is displayed on the first user interface. Moreover, the first user interface includes a multi-dimensional data presentation area, the multi-dimensional data presentation area includes a first information display area and a ticket information display area, and corresponding information is displayed in the corresponding areas.

It should be noted that the first information and the ticket information may form multi-dimensional data. The formed multi-dimensional data may be presented in the multi-dimensional data presentation area. Moreover, the multi-dimensional data further has a corresponding variation tendency chart. The multi-dimensional data and the variation tendency may both be presented in the multi-dimensional data presentation area in a variety of presentation manners, which are introduced and illustrated below through specific embodiments.

First, a variation tendency chart of the prices of tickets is displayed in the ticket information display area, and a variation tendency of the first information in the search time period is displayed in the first information display area.

For example, the variation tendency chart of the prices of tickets is presented in one of the following charts: a bar chart, a column chart, and a line chart. The variation tendency chart of the first information uses one or a combination of the following charts: a bar chart, a column chart, a pie chart, and a line chart.

The chart refers to a graphical structure that may visually display statistical information attributes (time, quantity, etc.) and play a key role in knowledge mining and intuitive visual perception of information, and is a good measure of “visualizing” object attribute data intuitively and vividly. The phenomenon of a certain thing or an abstract idea of a thought may be illustrated by a diagram or a table.

The bar chart, the column chart, the line chart and the pie chart are the four most common basic types of charts. The four charts may all be applied to the variation tendency chart of the first information. In addition, graphs such as an area map and a bubble chart may also be used.

The variation tendency chart of the prices of tickets is illustrated by a bar chart, a column chart, or a line chart.

For example, the first information includes a combination of one or more of the following information: weather information, traveler volume information, and hotel information.

When the first information includes the weather information, a variation tendency chart of the weather information of the travel destination in the search time period is displayed in the first information display area. Correspondingly, the multi-dimensional data display area including the first information display area and the ticket information display area includes: presenting, in the multi-dimensional data display area, a variation tendency chart of prices of tickets and the variation tendency chart of the weather information in the search time period; and presenting the variation tendency chart of the prices of tickets and the variation tendency chart of the weather information in the same chart by aggregation and superposition.

When the first information includes the traveler volume information of the travel destination at the various search time points in the search time period, a variation tendency chart of the traveler volume information of the travel destination at the various search time points in the search time period is displayed in the first information display area.

Correspondingly, the multi-dimensional data display area including the first information display area and the ticket information display area includes: presenting, in the multi-dimensional data presentation area, a variation tendency chart of prices of tickets and the variation tendency chart of the traveler volume information in the search time period; and presenting the variation tendency chart of the prices of tickets and the variation tendency chart of the traveler volume information in the same chart by aggregation and superposition.

The manners of aggregating the first information with the ticket information for presentation when the first information is one type of information are described above. The manners of aggregating the first information with the ticket information for presentation when the first information is multiple types of information are introduced and illustrated below.

The variation tendency chart of the prices of tickets and the variation tendency chart of the first information in the search time period are displayed in the multi-dimensional data display area; and the variation tendency chart of the prices of tickets and the variation tendency chart of the first information are presented in different presentation manners in the same chart by aggregation and superposition, and the presentation manners include: a column chart and a line chart.

Regardless how many types of information included in the first information, the information composed of the first information and the ticket information belongs to multi-dimensional data, and therefore, each type of information may be presented in a different chart. In the same figure, several different charts are aggregated and superposed in this manner to form a composite chart.

The aggregating and superposing are defined and introduced below. The composite chart after aggregation and superposition may have the same horizontal axis, and the horizontal axis may be defined as a time axis. The coordinates of the time axis represent respective search time points in the search time period, and the search time points are arranged in a chronological order. The vertical axis may be based on the data unit corresponding to the data illustrated in different charts.

For example, the variation tendency chart of the prices of tickets is illustrated by a column chart. The horizontal axis of the column chart is the time axis, and the vertical axis of the column chart is the price of the ticket. Correspondingly, when the weather information (air temperature) in the first information is illustrated by a line chart, the horizontal axis of the line chart is the time axis, and the vertical axis is temperature. However, when the column chart and the line chart are aggregated and superposed, they are superposed on the basis of time axis coordinates of the horizontal axis.

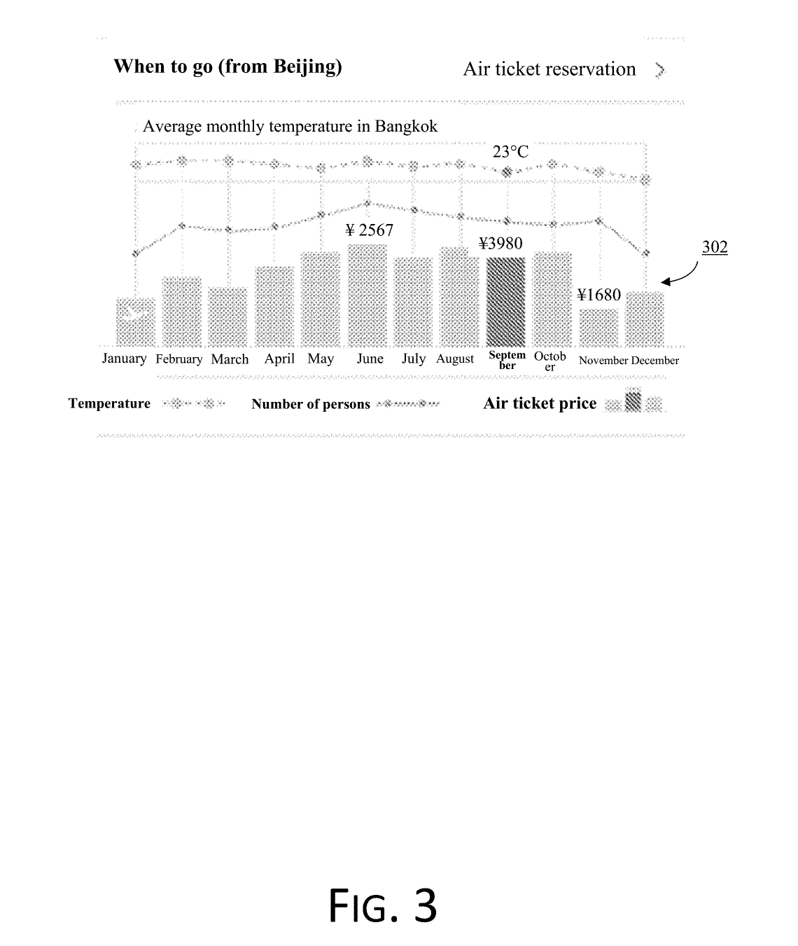

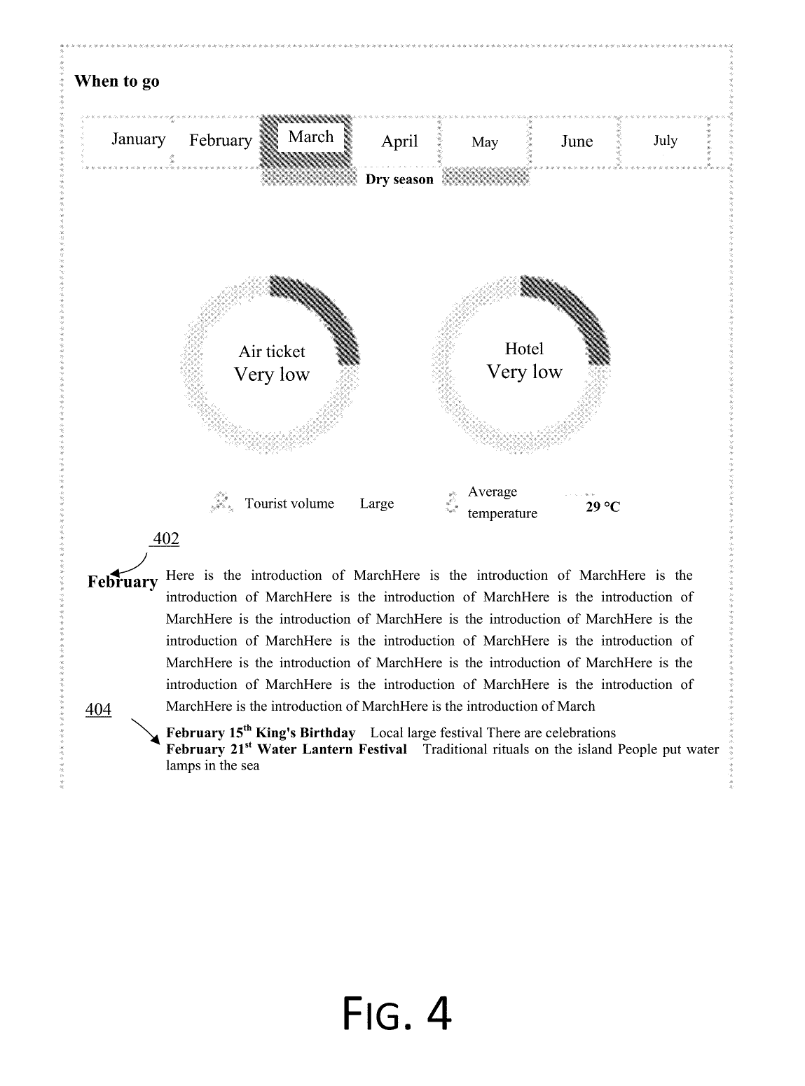

For example, FIG. 3 is a schematic diagram of presentation of the first information and the ticket information according to Embodiment 1 of the present disclosure, and FIG. 4 is a schematic diagram of event information presentation according to Embodiment 1 of the present disclosure. Referring to FIG. 3 and FIG. 4, illustration is made by taking the travel destination being Bangkok as an example.

As shown in FIG. 3, January to December are the respective search time points of the search time period, that is, the coordinates of the time axis. The variation tendency of the ticket price is presented by a column chart. The variation tendency of the temperature and the variation tendency of the traveler volume are illustrated by line charts, and for distinguishing the two line charts, the variation tendency of the temperature and the variation tendency of the traveler volume are illustrated by dotted lines and solid lines respectively.

In FIG. 3, the coordinates of the time axis are fixed, and corresponding data information is illustrated by different chart shapes respectively. The user may intuitively obtain a large amount of information according to the composite chart of variation tendencies to judge and decide the time and date for air ticket reservation according to the large amount of information.

In addition, although the hotel information is not introduced, the hotel information may be deduced based on the above ticket price and weather information. The hotel information may include information such as hotel price, hotel location, and hotel evaluation, and the information may be presented in a chart as described above and aggregated and superposed with the ticket price variation tendency chart on the same chart. Therefore, the user may view and compare multi-dimensional data conveniently.

Referring to FIG. 3, the average monthly air ticket price of Bangkok in one year is acquired. The air ticket data of Bangkok in one year is accessed from the air ticket business, and is aggregated to form the column chart 302 according to the monthly average price. The average monthly temperature in Bangkok in one year is acquired. The average temperature per month in Bangkok is acquired from the destination to form a dot chart. The average volume of travelers per month in Bangkok is acquired. By searching for the UV in Bangkok on the air travel platform, plus the number of people travelling acquired from Mafengwo, aggregation is made monthly to form the monthly number of visitors in Bangkok. Finally, the above three charts are aggregated for presentation by highlighting the ticket prices to form a large chart, as shown in FIG. 3.

In addition, when the first information includes event information of the travel destination, the event information is presented on the first user interface in the following manner.

The event information presented by identification information in the search time period is displayed in the first information display area. Correspondingly, the variation tendency chart of the prices of tickets and the identification information of the event information in the search time period are presented in the multi-dimensional data presentation area.

Traditional holiday information of the travel destination, low or peak travel season information of the travel destination, recommended travel attraction information of the travel destination, flowering season information of the travel destination, and the like may be presented in the first information presentation area. In addition, the identification information may be set for the event information. For example, the corresponding event information may be presented in the calendar through the identification information.

For example, the logo of “sakura” may be used as flowering season information of blooming of the sakura in the calendar to be illustrated in the calendar for the convenient view of the user.

FIG. 4 is a schematic diagram of event information presentation. For example, as shown in FIG. 4, there may be a specific introduction of a certain search time point 402, such as February as shown in FIG. 4, in the search time period, and an introduction of a corresponding festival 404, etc., such as February 15 King's Birthday and February 21 Water Lantern Festival, and the above information belongs to the event information. In addition, there may be some level information, for example, the price of air tickets from Beijing to Bangkok in March is lower, the hotel price is lower, the number of travelers is higher, and other messages of levels.

In addition, the first information and the ticket information may be displayed in various manners. For example, the first information and the ticket information of the current month are highlighted.

For example, the current system time is previously acquired. Then, the first information related to the travel destination in the search time period is displayed in the first information display area by highlight, and the ticket information is displayed in the ticket information display area by highlight.

For example, August in FIG. 2 and September in FIG. 3 are highlighted by styles that stand out from other months.

Moreover, in addition to displaying the corresponding search results in the first user interface, further operations may be performed on the search results. For example, after the displaying a first user interface of a search result, the method includes:

receiving a monitoring request of the user, wherein the monitoring request includes a monitoring behavior for a time period in the search time period; querying, according to the monitoring request, second information and ticket information corresponding to a specific time included in the time period; and displaying a second user interface of a monitoring result, wherein the second user interface includes a second information display area and a ticket information display area, the second information related to the travel destination corresponding to the specific time is displayed in the second information display area, and the ticket information is displayed in the ticket information display area.

For example, when the current first user interface is the case of FIG. 3, the unit time period is a calendar month; however, when the user needs to know a specific date of a calendar month, the calendar month may be expanded by a corresponding monitoring operation into a second user interface formed by days, from which the user may acquire corresponding information.

The above is the process of acquiring the corresponding information with the method and displaying it on the user interface. Therefore, the method includes extracting key factors affecting the user's decision, summarizing the decision factors of the various dimension monthly (unit time period), and forming a chart aggregating icons of the different dimensions. Therefore, the user may make comparison conveniently, and be provided with some key decision information conclusions, thus saving the user's time for searching in various channels and helping the user make decisions on the travel time.

The method provided by the present disclosure may be applied in various scenarios, and the application scenario includes an air travel application.

In addition, the method may not only help the user to make more accurate judgment and decision on the travel time in the scenario where the user purchases an air ticket, but also may integrate the function into one module and output it to other services and scenarios. For example, the module not only may be embedded in the air ticket service, but also may be output as a simple version to vacation and destination scenarios, because users in the vacation and destination scenarios will also be interested in a destination, such as Bangkok, and may go there at any time as long as the price, climate, and local conditions are appropriate.

In summary, in the method, first information and ticket information related to the travel destination are acquired according to the travel destination, and the information may provide valuable reference information for the user and is also some important key information to be considered for travelling to the destination. In general, the user may judge whether his/her travel condition is met according to the first information and the ticket information. Therefore, with the method provided by the present disclosure, through multi-dimensional compound information including the acquired first information and ticket information and the like, it may assist the user in deciding travel time from various perspectives, and it may improve user experience in information searching. The method reduces interaction frequencies between a server terminal and a client terminal and query frequencies through the server terminal, thus reducing the burden of the server. Meanwhile, the user may select time more conveniently, simply and quickly, thus enhancing the foresee-ability of the user and improving user experience.

A ticket-search based information providing method is further provided in Embodiment 2 of the present disclosure, and emphasizes operations at the server terminal.

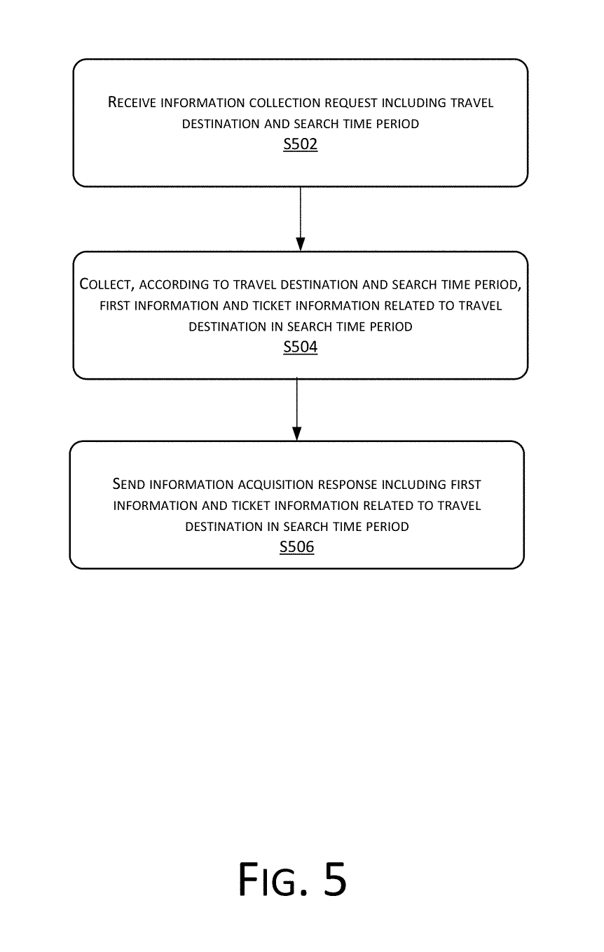

Please refer to FIG. 5 for specific operation steps. FIG. 5 is a flowchart of a ticket-search based information providing method according to Embodiment 2 of the present disclosure. In the method, a database is provided and includes a search destination, a travel destination, and first information related to the search destination or travel destination, and the first information includes multi-dimensional information.

For example, the method includes the following steps.

In step S502, an information collection request including the travel destination and a search time period is received.

This step is a process in which the server receives a request of a client terminal, and the information collection request includes some information related to the travel destination.

Still referring to FIG. 5, in step S504, first information and ticket information related to the travel destination in the search time period are acquired according to the travel destination and the search time period.

The step is a process in which the server collects information according to the received request, and the collected information forms the first information.

The travel destination is determined according to the relationship between the search destination and the travel destination in the database. The search destination may or may not be in line with the travel destination.

For the information involved in the above request, the acquired first information includes a combination of one or more of the following: weather information, traveler volume information, hotel price information, and the like.

It should be noted that the ticket includes an air ticket; the ticket information includes air ticket prices in the search time period; and the acquiring ticket information related to the travel destination in the search time period includes: acquiring the prices of air tickets from a travel departure place to the travel destination at the various search time points in the search time period.

The first information includes weather information of the travel destination, and the method of collecting the weather information includes: collecting the weather information of the travel destination at the various search time points in the search time period from the database.

The first information includes traveler volume information of the travel destination, and the traveler volume information is collected by: collecting an actual traveler volume of the travel destination at the various search time points in the search time period from the database; collecting a predicted traveler volume of the travel destination at the various search time points in the search time period from the database; and determining, according to the actual traveler volume and the predicted traveler volume, the traveler volume information at the various search time points in the search time period.

The first information includes traveler volume information of the travel destination, and the traveler volume information is collected by: collecting an actual traveler volume of the travel destination at the various search time points in the search time period from the database; collecting a predicted traveler volume of the travel destination at the various search time points in the search time period from the database; and determining, according to the actual traveler volume and the predicted traveler volume, the traveler volume information at the various search time points in the search time period.

The method of acquiring the first information and the ticket information is the same as the method of acquiring the first information and the ticket information provided by Embodiment 1 of the present disclosure. For the introduction of this part, reference may be made to partial description of Embodiment 1.

Still referring to FIG. 5, in step S506, an information acquisition response including the first information and the ticket information related to the travel destination in the search time period is sent.

The step is a process of sending the first information and the ticket information related to the travel destination in the search time period to the client terminal to facilitate the client terminal to display the first information and the ticket information on the user interface, so that the user may view and decide a travel date according to the first information and the ticket information conveniently.

In addition, after the sending an information acquisition response, the following operations are performed:

determining whether a monitoring request for a time object is received, wherein the monitoring request includes an area corresponding to the time object of the monitoring request; if so, querying, according to the time object of the monitoring request, second information and ticket information corresponding to the time object; and sending a monitoring response including the second information and the ticket information corresponding to the time object, wherein the second information is information related to the first information.

When the first information includes hotel price information of the travel destination, the method of acquiring the hotel price information includes: acquiring an average hotel price for each calendar month of the destination according to a hotel reservation system. The hotel price may be either the average price or the lowest price in the calendar month.

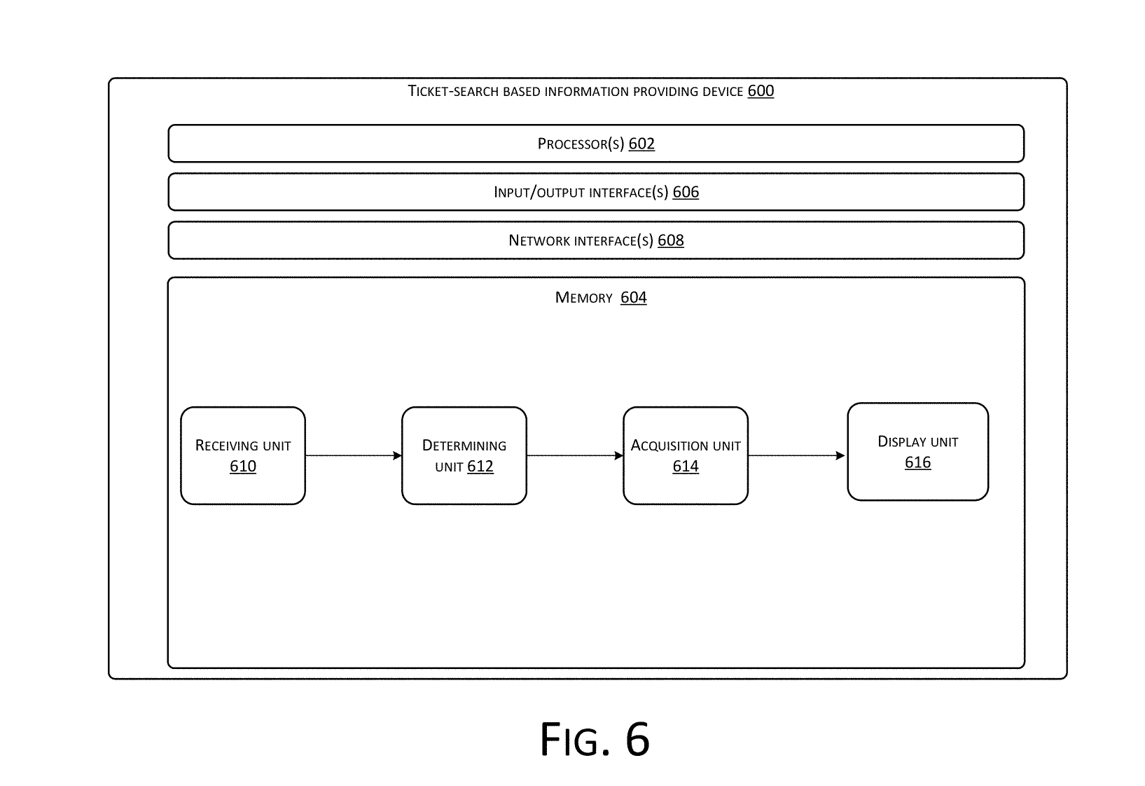

A ticket-search based information providing method is provided in the above Embodiment 1, and correspondingly, a ticket-search based information providing device is further provided in Embodiment 3 of the present disclosure. Referring to FIG. 6, a schematic diagram of an embodiment of a ticket-search based information providing device according to Embodiment 3 of the present disclosure is shown. The device embodiment is described in a relatively simple manner because it is similar to the method embodiment, and for related parts, reference may be made to the parts described in the method embodiment. The device embodiment described in the following is just schematic.

As shown in FIG. 6, a ticket-search based information providing device 600 in this embodiment includes one or more processor(s) 602 or data processing unit(s) and memory 604. The ticket-search based information providing device 600 may further include one or more input/output interface(s) 606 and one or more network interface(s) 608. The memory 604 is an example of computer readable medium or media.

The memory 604 may store therein a plurality of modules or units including:

a receiving unit 610 configured to receive a ticket search request of a user, wherein the search request includes a search destination;

a determining unit 612 configured to determine a travel destination for search and a search time period according to the search destination;

an acquisition unit 614 configured to acquire, according to the travel destination and the search time period, first information and ticket information related to the travel destination in the search time period; and

a display unit 616 configured to display a first user interface of a search result, wherein the first user interface includes a multi-dimensional data presentation area including a first information display area and a ticket information display area, the first information related to the travel destination in the search time period is displayed in the first information display area, and the ticket information is displayed in the ticket information display area.

For example, the determining unit 612 includes the following sub-units (not shown in FIG. 6(:

a determining sub-unit configured to judge whether the search destination has ticket-related information;

a related city acquisition sub-unit configured to, when a judgment result of the determining sub-unit is negative, acquire a related city of the search destination, wherein the related city includes a combination of one or more of the following cities: a city having a hierarchical relationship with the search destination, a city having a regional association with the search destination, and a city adjacent to the search destination; and

a destination determining sub-unit configured to determine the travel destination according to the related city of the search destination.

For example, the ticket is an air ticket, and the first information includes a combination of one or more of the following information: weather information, traveler volume information, and hotel information;

a variation tendency chart of prices of tickets and the variation tendency chart of the first information in the search time period are displayed in the multi-dimensional data display area; and

the variation tendency chart of the prices of tickets and the variation tendency chart of the first information are presented in different presentation manners in the same chart by aggregation and superposition, and the presentation manners include: a column chart and a line chart. For example, the display unit includes:

an identifying sub-unit configured to identify the multi-dimensional information respectively by different shapes; and

a superposing and presenting sub-unit configured to superpose the multi-dimensional information identified in different shapes for presentation in the same chart in a chronological order based on the same date.

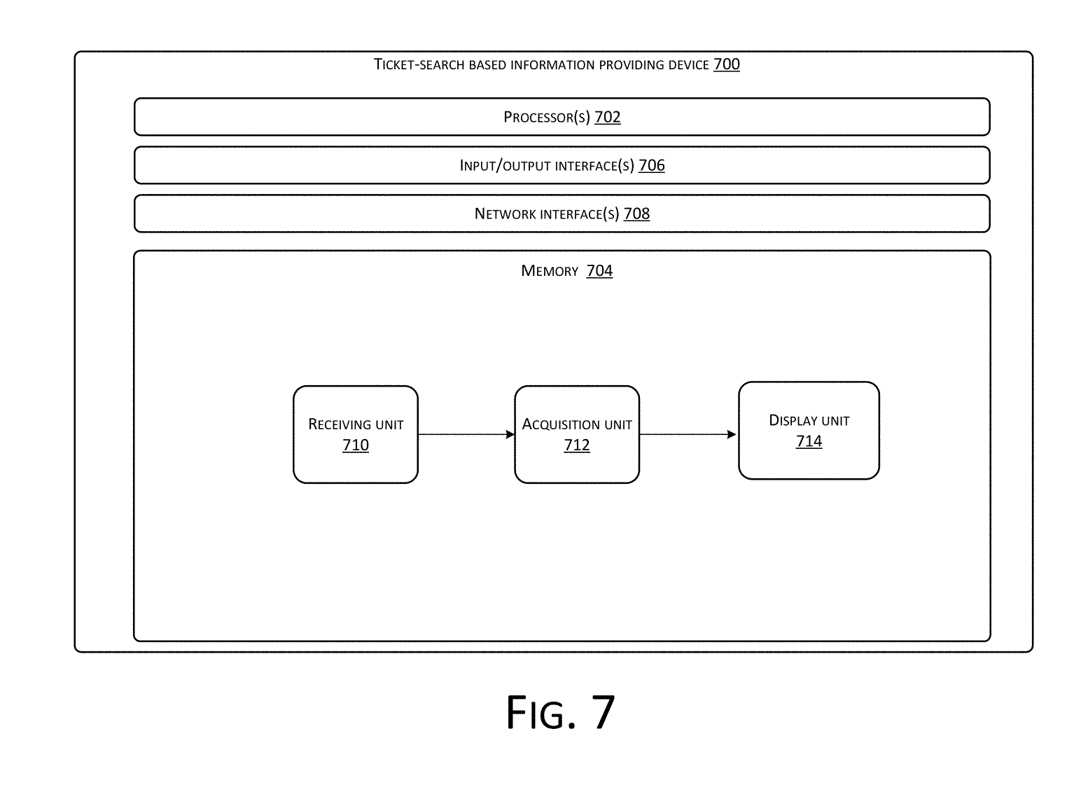

In addition, a ticket-search based information providing method is provided in the above Embodiment 2, and correspondingly, a ticket-search based information providing device is further provided in Embodiment 4 of the present disclosure. Referring to FIG. 7, a schematic diagram of an embodiment of a ticket-search based information providing device according to Embodiment 4 of the present disclosure is shown. The device embodiment is described in a relatively simple manner because it is similar to the method embodiment, and for related parts, reference may be made to the parts described in the method embodiment. The device embodiment described in the following is just schematic.

A ticket-search based information providing device in this embodiment is provided with a database, and the database includes a search destination, a travel destination and first information related to the search destination or travel destination, and the first information includes multi-dimensional information.

As shown in FIG. 7, a ticket-search based information providing device 700 in this embodiment includes one or more processor(s) 702 or data processing unit(s) and memory 704. The ticket-search based information providing device 700 may further include one or more input/output interface(s) 706 and one or more network interface(s) 708. The memory 704 is an example of computer readable medium or media.

The memory 704 may store therein a plurality of modules or units including:

a receiving unit 710 configured to receive an information collection request including the travel destination and a search time period;

an acquisition unit 712 configured to collect, according to the travel destination and the search time period, first information and ticket information related to the travel destination in the search time period; and

a sending unit 714 configured to send an information acquisition response including the first information and the ticket information related to the travel destination in the search time period.

For example, when the first information includes the weather information of the travel destination, the acquisition unit is configured to collect the weather information of the travel destination at the various search time points in the search time period from the database.

For example, when the first information includes the traveler volume information of the travel destination, the acquisition unit 712 includes the following sub-units (not shown in FIG. 7):

an actual traveler volume sub-unit configured to collect an actual traveler volume of the travel destination at the various search time points in the search time period from the database;

a predicted traveler volume sub-unit configured to collect a predicted traveler volume of the travel destination at the various search time points in the search time period from the database; and

a traveler volume information sub-unit configured to determine, according to the actual traveler volume and the predicted traveler volume, the traveler volume information at the various search time points in the search time period.

For example, the ticket-search based information providing device 700 further includes the following units (not shown in FIG. 7) stored in memory 704:

a determining unit configured to judge whether a monitoring request for a time object is received after the information acquisition response is sent, wherein the monitoring request includes an area corresponding to the time object of the monitoring request;

a query unit configured to, if a judgment result of the determining unit is positive, query, according to the time object of the monitoring request, second information and ticket information corresponding to the time object; and

a sending unit configured to send a monitoring response including the second information and the ticket information corresponding to the time object, wherein the second information is information related to the first information.

In addition, a ticket-search based information providing method is further provided in Embodiment 5 of the present disclosure, and is performed at the client terminal side. For example, the method includes the following steps:

receiving, by a client terminal, a ticket search request of a user, wherein the search request includes a search destination; sending a second search request to a server terminal, wherein the second search request includes a departure place, and a travel destination and a search time period related to the search destination determined according to the search destination; receiving a search result returned by the server terminal, wherein the search result includes first information and ticket information related to the travel destination in the search time period; and displaying a first user interface of the search result corresponding to the ticket search request, wherein the first user interface includes a multi-dimensional data presentation area including a first information display area and a ticket information display area, the first information related to the travel destination in the search time period is displayed in the first information display area, and the ticket information is displayed in the ticket information display area.

In this embodiment, the travel destination may be determined according to the search destination input by the user, and the step of determining, according to the search destination, the travel destination and the search time period related to the search destination is performed at the client terminal side. For example, a place database may be set at the client terminal side, and association relationships between multiple places are stored in the place database. The client terminal may determine, according to the search destination input by the user, the travel destination associated with the search destination according to the association relationships in the place database.

In a ticket search scenario, the departure place is further included in the second search request. A departure place input or selected by the user may be used as the departure place for the ticket search. A current city or place where the user is located may also be acquired through location information of the terminal as the departure place for the ticket search. Or, a default place of the system may also be used as the departure place.

For introductions of other steps in this embodiment, reference may be made to the introductions and illustrations of corresponding parts in Embodiment 1 of the present disclosure.

A ticket-search based information providing method is further provided in Embodiment 6 of the present disclosure. The method is performed at the server terminal side, and corresponds to the client terminal provided in Embodiment 5. For example, a database is provided and includes a travel destination and first information related to the travel destination.

The method includes: receiving a search request sent by a client terminal, wherein the search request includes a departure place, a travel destination, and a search time period; acquiring first information and ticket information related to the travel destination in the search time period; and returning a search result to the client terminal, wherein the search result includes the first information and the ticket information related to the travel destination in the search time period.

The embodiment is performed at the server terminal, the client terminal sends the search request to the server terminal after the client terminal determines the travel destination according to the search destination, and the search request includes the travel destination and the search time period. The server terminal acquires the first information and the ticket information related to the travel destination in the search time period according to the search request, and returns the search result to the client terminal.

A ticket-search based information providing method is further provided in Embodiment 7 of the present disclosure, and is performed at the client terminal. For example, the method includes the following steps:

receiving, by the client terminal, a ticket search request of a user, wherein the search request includes a search destination; sending a second search request to a server terminal, wherein the second search request includes a departure place, a search destination, and a search time period; receiving a search result returned by the server terminal, wherein the search result includes first information and ticket information related to the travel destination in the search time period, and the travel destination is associated with the search destination; and displaying a first user interface of the search result corresponding to the ticket search request, wherein the first user interface includes a multi-dimensional data presentation area including a first information display area and a ticket information display area, the first information related to the travel destination in the search time period is displayed in the first information display area, and the ticket information is displayed in the ticket information display area.

Differences between the methods provided in this embodiment and Embodiment 5 lie in that the determining the travel destination and the search time period according to the search destination is performed at the server terminal side, the client terminal sends the second search request to the server terminal, and the second search request includes the search destination and the search time period. The server terminal will determine the travel destination according to the association relationship between the search destination and the travel destination.

For other steps in this embodiment, reference may be made to the introductions and illustrations of identical parts in Embodiment 1 and Embodiment 5 of the present disclosure.

A ticket-search based information providing method is further provided in Embodiment 8 of the present disclosure. The method is performed at the server terminal, and corresponds to the client terminal in Embodiment 7. The method provides a database including a travel destination, first information related to the travel destination, and an association relationship between destinations.

The method includes: receiving a search request sent by a client terminal, wherein the search request includes a departure place, a search destination, and a search time period; determining, according to the search destination, a travel destination related to the search destination; acquiring first information and ticket information related to the travel destination in the search time period; and returning a search result to the client terminal, wherein the search result includes the first information and the ticket information related to the travel destination in the search time period.

This embodiment corresponds to the client terminal of Embodiment 7, the server terminal receives the search request sent by the client terminal, the search request includes the search destination and the search time period, and then the server terminal determines the travel destination according to the search destination.

For example, a place database may be previously configured at the server terminal side, and association relationships between multiple places are stored in the place database. The server terminal may acquire, according to the search destination input by the user, the travel destination having an association relationship with the search destination from the place database. The first information and the ticket information related to the travel destination in the search time period are acquired according to the determined travel destination and search time period, and the search result is finally returned to the client terminal.

For other steps in this embodiment, reference may be made to the introductions and illustrations of identical parts in the above embodiments.

The present disclosure is disclosed above by the preferred embodiments, but they are not intended to limit the present disclosure. Any person skilled in the art may make possible variations and modifications without departing from the spirit and scope of the present disclosure. The protection scope of the present disclosure should be subject to the scope defined in the claims of the present disclosure.

In a typical configuration, the computing device includes one or more central processing units (CPUs), an input/output interface, a network interface, and a memory. The memory may include computer readable media such as a volatile memory, a Random-Access Memory (RAM), and/or a non-volatile memory, e.g., a Read-Only Memory (ROM) or a flash RAM. The memory is an example of a computer readable medium.

The computer readable medium includes non-volatile and volatile media as well as movable and non-movable media, and may implement information storage by means of any method or technology. The information may be a computer readable instruction, a data structure, and a module of a program or other data. An example of the storage medium of a computer includes, but is not limited to, a phase change memory (PRAM), a static random access memory (SRAM), a dynamic random access memory (DRAM), other types of a RAM, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier wave.

Those skilled in the art should understand that the embodiments of the present disclosure may be provided as a method, a system, or a computer program product. Therefore, the present disclosure may be implemented in a form of a complete hardware embodiment, a complete software embodiment, or an embodiment combining software and hardware. Moreover, the present disclosure may be in the form of a computer program product implemented on one or more computer usable storage media (including, but are not limited to, a magnetic disk memory, a CD-ROM, an optical memory and the like) including computer usable program codes.

The present disclosure may further be understood with clauses as follows.

Clause 1. A ticket-search based information providing method comprising:

receiving a ticket search request of a user, wherein the search request comprises a search destination;

determining a travel destination for search and a search time period according to the search destination;

acquiring, according to the travel destination and the search time period, first information and ticket information related to the travel destination in the search time period; and

displaying a first user interface of a search result, wherein the first user interface comprises a multi-dimensional data presentation area comprising a first information display area and a ticket information display area, the first information related to the travel destination in the search time period is displayed in the first information display area, and the ticket information is displayed in the ticket information display area.

Clause 2. The ticket-search based information providing method of clause 1, wherein:

the ticket information comprises prices of tickets to the travel destination at various search time points in the search time period; and

a variation tendency chart of the prices of tickets is displayed in the ticket information display area.

Clause 3. The ticket-search based information providing method of clause 2, wherein:

the variation tendency chart of the prices of tickets is presented in one of the following charts: a bar chart, a column chart, and a line chart; and

a variation tendency of the first information in the search time period is displayed in the first information display area, and a variation tendency chart of the first information uses one or a combination of the following charts: a bar chart, a column chart, a pie chart, and a line chart.

Clause 4. The ticket-search based information providing method of clause 1, wherein the determining the travel destination for search comprises:

determining whether the search destination has ticket-related information;

when the search destination has no ticket-related information, acquiring a related city of the search destination, wherein the related city comprises a combination of one or more of the following cities: a city having a hierarchical relationship with the search destination, a city having a regional association with the search destination, and a city adjacent to the search destination; and

determining the travel destination according to the related city of the search destination.

Clause 5. The ticket-search based information providing method of clause 1, wherein:

the first information comprises weather information of the travel destination at various search time points in the search time period;

the acquiring the first information related to the travel destination in the search time period comprises: acquiring the weather information of the travel destination at the various search time points in the search time period, and a variation tendency of the weather information; and

a variation tendency chart of the weather information of the travel destination in the search time period is displayed in the first information display area.

Clause 6. The ticket-search based information providing method of clause 5, wherein the multi-dimensional data presentation area comprises the first information display area and the ticket information display area, further comprising:

presenting, in the multi-dimensional data presentation area, a variation tendency chart of prices of tickets and the variation tendency chart of the weather information in the search time period; and

presenting the variation tendency chart of the prices of tickets and the variation tendency chart of the weather information in the same chart by aggregation and superposition.

Clause 7. The ticket-search based information providing method of clause 1, wherein:

the first information comprises traveler volume information of the travel destination at various search time points in the search time period; and

the acquiring the first information related to the travel destination in the search time period comprises:

acquiring an actual traveler volume of the travel destination at the various search time points in the search time period;

acquiring a predicted traveler volume of the travel destination at the various search time points in the search time period;

determining, according to the actual traveler volume and the predicted traveler volume, the traveler volume information of the travel destination at the various search time points in the search time period and a variation tendency of the traveler volume information in the search time period; and

displaying, in the first information display area, a variation tendency chart of the traveler volume information of the travel destination at the various search time points in the search time period.

Clause 8. The ticket-search based information providing method of clause 7, wherein the multi-dimensional data presentation area comprises the first information display area and the ticket information display area, further comprising:

presenting, in the multi-dimensional data presentation area, a variation tendency chart of prices of tickets and the variation tendency chart of the traveler volume information in the search time period; and

presenting the variation tendency chart of the prices of tickets and the variation tendency chart of the traveler volume information in the same chart by aggregation and superposition.

Clause 9. The ticket-search based information providing method of clause 7, wherein:

the acquiring the predicted traveler volume of the travel destination at the various search time points in the search time period comprises: acquiring, based on a travel platform, a volume of independent visitors who search for the travel destination, and using the volume of independent visitors as the predicted traveler volume; and

the determining, according to the actual traveler volume and the predicted traveler volume, the traveler volume information of the travel destination at the various search time points in the search time period and the variation tendency of the traveler volume information in the search time period comprises:

adding the actual traveler volume and the volume of independent visitors as the traveler volume information; and

determining, according to the traveler volume information at the various search time points in the search time, a variation tendency of the traveler volume information in the search time period.

Clause 10. The ticket-search based information providing method of clause 1, wherein:

the first information comprises event information of the travel destination;

the event information comprises a combination of one or more of the following information: traditional holiday information of the travel destination, low or peak travel season information of the travel destination, recommended travel attraction information of the travel destination, and flowering season information of the travel destination;

the event information presented by identification information in the search time period is displayed in the first information display area; and

a variation tendency chart of prices of tickets and the identification information of the event information in the search time period are presented in the multi-dimensional data presentation area.

Clause 11. The ticket-search based information providing method of clause 1, wherein:

the ticket is an air ticket, and the first information comprises a combination of one or more of the following information: weather information, traveler volume information, and hotel information;

a variation tendency chart of prices of tickets and the variation tendency chart of the first information in the search time period are displayed in the multi-dimensional data display area; and

the variation tendency chart of the prices of tickets and the variation tendency chart of the first information are presented in different presentation manners in the same chart by aggregation and superposition, and the presentation manners comprise a column chart and a line chart.

Clause 12. The ticket-search based information providing method of clause 1, wherein the determining the search time period comprises:

setting a default time period of a system; or determining a search start date of the search time period according to a current system time, and determining a search end date of the search time period according to the determined search start data and a search time length set by default; and

calculating the search time length in a calculation unit of a day or a month.

Clause 13. The ticket-search based information providing method of clause 1, wherein:

the method further comprises acquiring a current system time in advance; and

the displaying the first user interface of the search result, wherein the first information related to the travel destination in the search time period is displayed in the first information display area, and the ticket information is displayed in the ticket information display area, comprises:

displaying the first information related to the travel destination in the search time period in the first information display area by highlight, and displaying the ticket information in the ticket information display area by highlight.

Clause 14. The ticket-search based information providing method of clause 1, wherein after the displaying the first user interface of the search result, the method further comprises:

receiving a monitoring request of the user, wherein the monitoring request comprises a monitoring behavior for a time period in the search time period;

querying, according to the monitoring request, second information and ticket information corresponding to a specific time comprised in the time period; and

displaying a second user interface of a monitoring result, wherein the second user interface comprises a second information display area and a ticket information display area, the second information related to the travel destination corresponding to the specific time is displayed in the second information display area, and the ticket information is displayed in the ticket information display area, wherein:

the second information related to the travel destination corresponding to the specific time comprises information related to the first information.

Clause 15. A ticket-search based information providing method, wherein a database is provided and the database includes a travel destination and first information related to the travel destination, and the first information includes multi-dimensional information, the method comprising:

receiving an information collection request comprising the travel destination and a search time period;

collecting, according to the travel destination and the search time period, first information and ticket information related to the travel destination in the search time period; and

sending an information acquisition response comprising the first information and the ticket information related to the travel destination in the search time period.

Clause 16. The ticket-search based information providing method of clause 15, wherein:

the first information comprises weather information of the travel destination; and

the weather information is collected by:

collecting the weather information of the travel destination at various search time points in the search time period from the database.

Clause 17. The ticket-search based information providing method of clause 15, wherein:

the first information comprises traveler volume information of the travel destination; and

the traveler volume information is collected by:

collecting an actual traveler volume of the travel destination at various search time points in the search time period from the database;

collecting a predicted traveler volume of the travel destination at the various search time points in the search time period from the database; and

determining, according to the actual traveler volume and the predicted traveler volume, the traveler volume information at the various search time points in the search time period.

Clause 18. The ticket-search based information providing method of clause 17, wherein the determining, according to the actual traveler volume and the predicted traveler volume, the traveler volume information at the various search time points in the search time period comprises:

determining the traveler volume information by adding the actual traveler volume and the predicted traveler volume; or

setting a corresponding weight for the actual traveler volume and the predicted traveler volume respectively, and determining the traveler volume information by adding the weighted actual traveler volume and the weighted predicted traveler volume.

Clause 19. The ticket-search based information providing method of clause 15, wherein:

the ticket includes an air ticket and the ticket information comprises prices of air tickets in the search time period; and

the acquiring ticket information related to the travel destination in the search time period comprises: acquiring the prices of the air tickets from a travel departure place to the travel destination at various search time points in the search time period.

Clause 20. The ticket-search based information providing method of clause 15, wherein after the sending an information acquisition response, further comprising:

determining whether a monitoring request for a time object is received, wherein the monitoring request comprises an area corresponding to the time object of the monitoring request;

when a monitoring request for a time object is received, querying, according to the time object of the monitoring request, second information and ticket information corresponding to the time object; and

sending a monitoring response comprising the second information and the ticket information corresponding to the time object, wherein the second information is information related to the first information.

Clause 21. A ticket-search based information providing device comprising:

a receiving unit configured to receive a ticket search request of a user, wherein the search request comprises a search destination;

a determining unit configured to determine a travel destination for search and a search time period according to the search destination;

an acquisition unit configured to acquire, according to the travel destination and the search time period, first information and ticket information related to the travel destination in the search time period; and

a display unit configured to display a first user interface of a search result, wherein the first user interface comprises a multi-dimensional data presentation area comprising a first information display area and a ticket information display area, the first information related to the travel destination in the search time period is displayed in the first information display area, and the ticket information is displayed in the ticket information display area.

Clause 22. The ticket-search based information providing device of clause 21, wherein the determining unit comprises:

a determining sub-unit configured to judge whether the search destination has ticket-related information;

a related city acquisition sub-unit configured to, when a judgment result of the determining sub-unit is negative, acquire a related city of the search destination, wherein the related city comprises a combination of one or more of the following cities: a city having a hierarchical relationship with the search destination, a city having a regional association with the search destination, and a city adjacent to the search destination; and

a destination determining sub-unit configured to determine the travel destination according to the related city of the search destination.

Clause 23. The ticket-search based information providing device of clause 21, wherein:

the ticket is an air ticket, and the first information comprises a combination of one or more of the following information weather information, traveler volume information, and hotel information;

a variation tendency chart of prices of tickets and the variation tendency chart of the first information in the search time period are displayed in the multi-dimensional data display area; and

the variation tendency chart of the prices of tickets and the variation tendency chart of the first information are presented in different presentation manners in the same chart by aggregation and superposition, and the presentation manners comprise: a column chart and a line chart.

Clause 24. A ticket-search based information providing device, wherein a database is provided and the database includes a travel destination and first information related to the travel destination, and the first information includes multi-dimensional information, the device comprising:

a receiving unit configured to receive an information collection request comprising the travel destination and a search time period;

an acquisition unit configured to collect, according to the travel destination and the search time period, first information and ticket information related to the travel destination in the search time period; and

a sending unit configured to send an information acquisition response comprising the first information and ticket information related to the travel destination in the search time period.

Clause 25. The ticket-search based information providing device of clause 24, wherein:

the first information comprises weather information of the travel destination; and

the acquisition unit is specifically configured to collect the weather information of the travel destination at various search time points in the search time period from the database.

Clause 26. The ticket-search based information providing device of clause 24, wherein:

the first information comprises traveler volume information of the travel destination; and

the acquisition unit comprises:

an actual traveler volume sub-unit configured to collect an actual traveler volume of the travel destination at various search time points in the search time period from the database;

a predicted traveler volume sub-unit configured to collect a predicted traveler volume of the travel destination at the various search time points in the search time period from the database; and

a traveler volume information sub-unit configured to determine, according to the actual traveler volume and the predicted traveler volume, the traveler volume information at the various search time points in the search time period.

Clause 27. The ticket-search based information providing device of clause 24, further comprising:

a determining unit configured to judge whether a monitoring request for a time object is received after the information acquisition response is sent, wherein the monitoring request comprises an area corresponding to the time object of the monitoring request;

a query unit configured to, when a judgment result of the determining unit is positive, query, according to the time object of the monitoring request, second information and ticket information corresponding to the time object; and

a sending unit configured to send a monitoring response comprising the second information and the ticket information corresponding to the time object, wherein the second information is information related to the first information.

Clause 28. A ticket-search based information providing method comprising:

receiving, by a client terminal, a ticket search request of a user, the search request including a search destination;

sending a second search request to a server terminal, the second search request including a departure place, and a travel destination and a search time period related to the search destination determined according to the search destination;

receiving a search result returned by the server terminal, the search result including first information and ticket information related to the travel destination in the search time period; and

displaying a first user interface of the search result corresponding to the ticket search request, the first user interface including a multi-dimensional data presentation area comprising a first information display area and a ticket information display area, wherein the first information related to the travel destination in the search time period is displayed in the first information display area, and the ticket information is displayed in the ticket information display area.

Clause 29. A ticket-search based information providing method, wherein a database is provided and the database includes a travel destination and first information related to the travel destination, the method comprising:

receiving a search request sent by a client terminal, wherein the search request comprises a departure place, a travel destination, and a search time period;

acquiring first information and ticket information related to the travel destination in the search time period; and

returning a search result to the client terminal, wherein the search result comprises the first information and the ticket information related to the travel destination in the search time period.

Clause 30. A ticket-search based information providing method comprising:

receiving, by a client terminal, a ticket search request of a user, wherein the search request comprises a search destination;

sending a second search request to a server terminal, wherein the second search request comprises a departure place, a search destination, and a search time period;

receiving a search result returned by the server terminal, wherein the search result comprises first information and ticket information related to a travel destination in the search time period; and the travel destination is associated with the search destination; and

displaying a first user interface of the search result corresponding to the ticket search request, wherein the first user interface comprises a multi-dimensional data presentation area comprising a first information display area and a ticket information display area, the first information related to the travel destination in the search time period is displayed in the first information display area, and the ticket information is displayed in the ticket information display area.

Clause 31. A ticket-search based information providing method, wherein a database is provided and the database includes a travel destination, first information related to the travel destination, and an association relationship between destinations, the method comprising:

receiving a search request sent by a client terminal, wherein the search request comprises a departure place, a search destination, and a search time period;

determining, according to the search destination, the travel destination related to the search destination;

acquiring first information and ticket information related to the travel destination in the search time period; and

returning a search result to the client terminal, wherein the search result comprises the first information and the ticket information related to the travel destination in the search time period.

What is claimed is:

1. A method comprising:
receiving a ticket search request of a user, the search request including a search destination;
determining a travel destination for search and a search time period according to the search destination;
acquiring, according to the travel destination and the search time period, first information and ticket information related to the travel destination in the search time period;
displaying a first user interface of a search result, the first user interface including a multi-dimensional data presentation area including a first information display area and a ticket information display area; and
displaying the first information related to the travel destination in the search time period in the first information display area, and the ticket information in the ticket information display area.

2. The method of claim 1, wherein:
the ticket information includes prices of tickets to the travel destination at various search time points in the search time period; and
the method further comprises displaying a variation tendency chart of the prices of tickets in the ticket information display area.

3. The method of claim 2, wherein:
the variation tendency chart of the prices of tickets is presented in one of the following charts: a bar chart, a column chart, and a line chart; and
the method further comprises displaying a variation tendency of the first information in the search time period in the first information display area, the variation tendency chart of the first information including one or a combination of the following charts: a bar chart, a column chart, a pie chart, and a line chart.

4. The method of claim 1, wherein the determining the travel destination for search includes:
determining whether the search destination has ticket-related information;
in response to a determination that the search destination has no ticket-related information,
acquiring a related city of the search destination, the related city including a combination of one or more of the following cities: a city having a hierarchical relationship with the search destination, a city having a regional association with the search destination, and a city adjacent to the search destination; and
determining the travel destination according to the related city of the search destination.

5. The method of claim 1, wherein:
the first information includes weather information of the travel destination at various search time points in the search time period;
the acquiring the first information related to the travel destination in the search time period includes acquiring the weather information of the travel destination at the various search time points in the search time period, and a variation tendency of the weather information; and
displaying a variation tendency chart of the weather information of the travel destination in the search time period in the first information display area.

6. The method of claim 5, wherein:
the multi-dimensional data presentation area includes the first information display area and the ticket information display area; and
the method further comprises:
presenting, in the multi-dimensional data presentation area, a variation tendency chart of prices of tickets and the variation tendency chart of the weather information in the search time period; and
presenting the variation tendency chart of the prices of tickets and the variation tendency chart of the weather information in the same chart by aggregation and superposition.

7. The method of claim 1, wherein:
the first information comprises traveler volume information of the travel destination at various search time points in the search time period; and
the acquiring the first information related to the travel destination in the search time period includes:
acquiring an actual traveler volume of the travel destination at the various search time points in the search time period;
acquiring a predicted traveler volume of the travel destination at the various search time points in the search time period;
determining, according to the actual traveler volume and the predicted traveler volume, the traveler volume information of the travel destination at the various search time points in the search time period and a variation tendency of the traveler volume information in the search time period; and
displaying, in the first information display area, a variation tendency chart of the traveler volume information of the travel destination at the various search time points in the search time period.

8. The method of claim 7, wherein:
the multi-dimensional data presentation area includes the first information display area and the ticket information display area; and
the method further comprises:
presenting, in the multi-dimensional data presentation area, a variation tendency chart of prices of tickets and the variation tendency chart of the traveler volume information in the search time period; and
presenting the variation tendency chart of the prices of tickets and the variation tendency chart of the traveler volume information in the same chart by aggregation and superposition.

9. The method of claim 7, wherein:
the acquiring the predicted traveler volume of the travel destination at the various search time points in the search time period comprises: acquiring, based on a travel platform, a volume of independent visitors who search for the travel destination, and using the volume of independent visitors as the predicted traveler volume; and
the determining, according to the actual traveler volume and the predicted traveler volume, the traveler volume information of the travel destination at the various search time points in the search time period and the variation tendency of the traveler volume information in the search time period includes:
adding the actual traveler volume and the volume of independent visitors as the traveler volume information; and
determining, according to the traveler volume information at the various search time points in the search time, a variation tendency of the traveler volume information in the search time period.

10. The method of claim 1, wherein:
the first information includes event information of the travel destination;
the event information includes a combination of one or more of the following information: traditional holiday information of the travel destination, low or peak travel season information of the travel destination, recommended travel attraction information of the travel destination, and flowering season information of the travel destination; and
the method further comprises:
displaying the event information presented by identification information in the search time period in the first information display area; and
displaying a variation tendency chart of prices of tickets and the identification information of the event information in the search time period in the multi-dimensional data presentation area.

11. The method of claim 1, wherein:
the ticket is an air ticket and the first information comprises a combination of one or more of the following information: weather information, traveler volume information, and hotel information; and
the method further comprises:
displaying a variation tendency chart of prices of tickets and the variation tendency chart of the first information in the search time period in the multi-dimensional data display area; and
displaying the variation tendency chart of the prices of tickets and the variation tendency chart of the first information in different presentation manners in the same chart by aggregation and superposition, and the presentation manners comprise a column chart and a line chart.

12. The method of claim 1, wherein the determining the search time period includes:
setting a default time period of a system; or determining a search start date of the search time period according to a current system time, and determining a search end date of the search time period according to the determined search start data and a search time length set by default; and
calculating the search time length in a calculation unit of a day or a month.

13. The method of claim 1, wherein:
the method further comprises acquiring a current system time in advance; and
the displaying the first user interface of the search result includes:
displaying the first information related to the travel destination in the search time period in the first information display area by highlight; and
displaying the ticket information in the ticket information display area by highlight.

14. The method of claim 1, wherein after the displaying the first user interface of the search result, the method further comprises:
receiving a monitoring request of the user, wherein the monitoring request comprises a monitoring behavior for a time period in the search time period;
querying, according to the monitoring request, second information and ticket information corresponding to a specific time comprised in the time period; and
displaying a second user interface of a monitoring result, wherein the second user interface comprises a second information display area and a ticket information display area, the second information related to the travel destination corresponding to the specific time is displayed in the second information display area, and the ticket information is displayed in the ticket information display area, the second information related to the travel destination corresponding to the specific time including information related to the first information.

15. One or more memories stored thereon computer readable instructions that, when executed by one or more processors, cause the one or more processors to perform acts comprising:
receiving an information collection request including a travel destination and a search time period;
collecting, according to the travel destination and the search time period, first information and ticket information related to the travel destination in the search time period; and
sending an information acquisition response including the first information and the ticket information related to the travel destination in the search time period.

16. The one or more memories of claim 15, wherein:
the first information comprises weather information of the travel destination; and
the method further comprises collecting the weather information, the collecting the weather information including collecting the weather information of the travel destination at various search time points in the search time period from a database.

17. The one or more memories of claim 15, wherein:
the first information comprises traveler volume information of the travel destination; and
the method further comprises collecting the traveler information, the collecting the traveler information including:
collecting an actual traveler volume of the travel destination at various search time points in the search time period from the database;
collecting a predicted traveler volume of the travel destination at the various search time points in the search time period from the database; and
determining, according to the actual traveler volume and the predicted traveler volume, the traveler volume information at the various search time points in the search time period.

18. The one or more memories of claim 17, wherein the determining, according to the actual traveler volume and the predicted traveler volume, the traveler volume information at the various search time points in the search time period includes:
determining the traveler volume information by adding the actual traveler volume and the predicted traveler volume; or
setting a corresponding weight for the actual traveler volume and the predicted traveler volume respectively, and determining the traveler volume information by adding the weighted actual traveler volume and the weighted predicted traveler volume.

19. The one or more memories of claim 15, wherein:
the ticket includes an air ticket and the ticket information comprises prices of air tickets in the search time period; and
the acquiring ticket information related to the travel destination in the search time period comprises: acquiring the prices of the air tickets from a travel departure place to the travel destination at various search time points in the search time period.

20. A device comprising:
one or more processors; and
one or more memories stored thereon computer readable instructions that, when executed by the one or more processors, cause the one or more processors to perform acts comprising:
receiving a ticket search request of a user, the search request including a search destination;
determining a travel destination for search and a search time period according to the search destination;
acquiring, according to the travel destination and the search time period, first information and ticket information related to the travel destination in the search time period;
displaying a first user interface of a search result, the first user interface including a multi-dimensional data presentation area including a first information display area and a ticket information display area; and
displaying the first information related to the travel destination in the search time period in the first information display area, and the ticket information in the ticket information display area.
